(19) United States
(12) Patent Application Publication
(10) Pub. No.: US 2021/0314951 A1
(43) Pub. Date: Oct. 7, 2021

(54) APPARATUSES AND METHODS FOR UPLINK TRANSMISSION USING A MULTI-USER PHYSICAL LAYER PROTOCOL DATA UNIT (MU PPDU) WITH A SINGLE RESOURCE UNIT (RU)

(71) Applicant: MEDIATEK INC., Hsinchu City (TW)

(72) Inventors: Cheng-Yi CHANG, Hsinchu City (TW); Chao-Wen CHOU, Hsinchu City (TW); Kun-Sheng HUANG, Hsinchu City (TW); Fu-Yu TSAI, Hsinchu City (TW); Hung-Tao HSIEH, Hsinchu City (TW)

(21) Appl. No.: 17/205,157

(22) Filed: Mar. 18, 2021

Related U.S. Application Data
(60) Provisional application No. 63/006,143, filed on Apr. 7, 2020.

(51) Int. Cl. H04W 72/04; H04W 74/08; H04L 1/00

(52) U.S. Cl. CPC H04W 72/0493; H04W 72/0453; H04L 1/0008; H04W 74/0816; H04W 72/042

(57) ABSTRACT

A wireless communication terminal including a wireless transceiver and a controller is provided. The wireless transceiver performs wireless transmission and reception to and from an AP. The controller is coupled to the wireless transceiver, and is operable to configure the wireless communication terminal to operate as a non-AP STA, and transmit a MU PPDU with a single RU spanning a partial bandwidth of the MU PPDU to the AP via the wireless transceiver. In particular, the partial bandwidth excludes a frequency band of a primary channel.

### CROSS REFERENCE TO RELATED APPLICATIONS

This application claims priority of U.S. Provisional Application No. 63/006,143, filed on Apr. 7, 2020, the entirety of which is incorporated by reference herein.

### BACKGROUND OF THE APPLICATION

### Field of the Application

The application generally relates to wireless communications, and more particularly, to apparatuses and methods for efficient uplink transmission using a Multi-User Physical layer Protocol Data Unit (MU PPDU) with a single Resource Unit (RU).

### Description of the Related Art

With growing demand for ubiquitous computing and networking, various wireless technologies have been developed, including Wireless-Fidelity (Wi-Fi) which is a Wireless Local Area Network (WLAN) technology allowing mobile devices, such as a smartphone, a smart pad, a laptop computer, a portable multimedia player, an embedded apparatus, or the like, to obtain wireless services in a frequency band of 2.4 GHz, 5 GHz or 60 GHz.

The Institute of Electrical and Electronics Engineers (IEEE) 802.11 has commercialized or developed various technological standards since an initial WLAN technology is supported using frequencies of 2.4 GHz. For example, IEEE 802.11ac supports Multi-User (MU) transmission using spatial degrees of freedom via a MU-Multiple Input-Multiple-Output (MU-MIMO) scheme in a downlink (DL) direction from an Access Point (AP) to Stations (STAs). To improve the performance experienced by users of the aforementioned mobile devices, who demand high-capacity and high-rate services, IEEE 802.11ax has been proposed, which uses both Orthogonal Frequency Division Multiple Access (OFDMA) and/or MU-MIMO in both DL and uplink (UL) directions. That is, in addition to supporting frequency and spatial multiplexing from an AP to multiple STAs, transmissions from multiple STAs to the AP are also supported in IEEE 802.11ax.

In IEEE 802.11ax, an RU refers to a group of 78.125 KHz bandwidth subcarriers (tones) used in both DL and UL transmissions for a single STA, and a MU PPDU may carry multiple RUs, allowing multiple users to access an AP simultaneously and efficiently. In particular, the IEEE 802.11ax standards deliberately leave out the case of transmitting an UL MU PPDU with a single RU.

### BRIEF SUMMARY OF THE APPLICATION

In order to improve the efficiency or flexibility for an STA to access the wireless medium, the present application proposes specific measures to allow a non-AP STA to perform uplink transmission using an MU PPDU with a single RU spanning partial bandwidth of the MU PPDU, wherein the subcarriers corresponding to the rest of the bandwidths except for the primary channel are punctured.

In a first aspect of the application, a wireless communication terminal comprising a wireless transceiver and a controller is provided. The wireless transceiver is configured to perform wireless transmission and reception to and from an AP. The controller is coupled to the wireless transceiver, and operable to configure the wireless communication terminal to operate as a non-AP STA, and transmit a MU PPDU with a single RU spanning a partial bandwidth of the MU PPDU to the AP via the wireless transceiver, wherein the partial bandwidth excludes a frequency band of a primary channel.

In a first implementation form of the first aspect, the MU PPDU is a High Efficiency (HE) MU PPDU in compliance with IEEE 802.11ax standards.

In a second implementation form of the first aspect, a preamble of the HE MU PPDU comprises an HE signal B (HE-SIG-B) field which is separately encoded on each 20 MHz band.

In a third implementation form of the first aspect in combination with the second implementation form of the first aspect, the HE-SIG-B field comprises a common field and a user specific field, the common field comprises a first RU allocation subfield corresponding to the primary channel and a second RU allocation subfield corresponding to the RU, and the user specific field comprises a first STA-ID subfield corresponding to the first RU allocation subfield and a second STA-ID subfield corresponding to the second RU allocation subfield.

In a fourth implementation form of the first aspect in combination with the third implementation form of the first aspect, the controller further sets the first STA-ID subfield to a value indicating an unallocated RU, and sets the second STA-ID subfield to a STA Identifier (ID) of the non-AP HE STA.

In a fifth implementation form of the first aspect in combination with the third implementation form of the first aspect, the controller further sets the first RU allocation subfield to a value indicating a 242-tone RU, and sets the second RU allocation subfield to a value indicating a 484-tone RU or a 996-tone RU.

In a sixth implementation form of the first aspect in combination with the fifth implementation form of the first aspect, the controller further fills the 242-tone RU with dummy bits.

In a seventh implementation form of the first aspect in combination with the third implementation form of the first aspect, the HE-SIG-B field comprises a first HE-SIG-B content channel and a second HE-SIG-B content channel, the common field is a first common field corresponding to the first HE-SIG-B content channel, and the user specific field is a first user specific field corresponding to the first HE-SIG-B content channel.

In an eighth implementation form of the first aspect, the controller further performs a Clear Channel Assessment (CCA) on each 20 MHz band, and the partial bandwidth excludes one or more 20 MHz bands which the CCA indicates busy.

In a second aspect of the application, a method executed by a wireless communication terminal is provided. The method comprises the following steps: configuring the wireless communication terminal to operate as a non-AP STA; and transmitting an MU PPDU with a single RU spanning a partial bandwidth of the MU PPDU to an AP, wherein the partial bandwidth excludes a frequency band of a primary channel.

In a first implementation form of the second aspect, the MU PPDU is an HE MU PPDU in compliance with IEEE 802.11ax standards.

In a second implementation form of the second aspect, a preamble of the HE MU PPDU comprises an HE-SIG-B field which is separately encoded on each 20 MHz band.

In a third implementation form of the second aspect in combination with the second implementation form of the second aspect, the HE-SIG-B field comprises a common field and a user specific field, the common field comprises a first RU allocation subfield corresponding to the primary channel and a second RU allocation subfield corresponding to the RU, and the user specific field comprises a first STA-ID subfield corresponding to the first RU allocation subfield and a second STA-ID subfield corresponding to the second RU allocation subfield.

In a fourth implementation form of the second aspect in combination with the third implementation form of the second aspect, the method further comprises the following steps: setting the first STA-ID subfield to a value indicating an unallocated RU; and setting the second STA-ID subfield to a STA ID of the non-AP HE STA.

In a fifth implementation form of the second aspect in combination with the third implementation form of the second aspect, the method further comprises the following steps: setting the first RU allocation subfield to a value indicating a 242-tone RU; and setting the second RU allocation subfield to a value indicating a 484-tone RU or a 996-tone RU.

In a sixth implementation form of the second aspect in combination with the fifth implementation form of the second aspect, the method further comprises the following step: filling the 242-tone RU with dummy bits.

In a seventh implementation form of the second aspect in combination with the third implementation form of the second aspect, the HE-SIG-B field comprises a first HE-SIG-B content channel and a second HE-SIG-B content channel, the common field is a first common field corresponding to the first HE-SIG-B content channel, and the user specific field is a first user specific field corresponding to the first HE-SIG-B content channel.

In an eighth implementation form of the second aspect, the method further comprises the following step: performing a CCA on each 20 MHz band, wherein the partial bandwidth excludes one or more 20 MHz bands which the CCA indicates busy.

Other aspects and features of the present application will become apparent to those with ordinary skill in the art upon review of the following descriptions of specific embodiments of the apparatuses and methods for uplink transmission using an MU PPDU with a single RU.

### BRIEF DESCRIPTION OF DRAWINGS

The application can be more fully understood by reading the subsequent detailed description and examples with references made to the accompanying drawings, wherein:

FIG. 1 is a block diagram of a wireless communication system according to an embodiment of the application;

FIG. 2 is a block diagram illustrating an STA according to an embodiment of the application;

FIG. 3 is a schematic diagram illustrating the format of an UL HE MU PPDU according to an embodiment of the application;

FIG. 4 is a schematic diagram illustrating the HE-SIG-B content channels and their duplication in an 80 MHz HE MU PPDU according to an embodiment of the application;

FIG. 5 is a schematic diagram illustrating the RU allocation of an UL MU PPDU according to an embodiment of the application;

FIG. 6 is a schematic diagram illustrating the RU allocation of an UL MU PPDU according to another embodiment of the application;

FIG. 7 is a schematic diagram illustrating the RU allocation of an UL MU PPDU according to another embodiment of the application;

FIG. 8 is a schematic diagram illustrating the RU allocation of an UL MU PPDU according to another embodiment of the application;

FIG. 9 is a schematic diagram illustrating the RU allocation of an UL MU PPDU according to another embodiment of the application; and

FIG. 10 is a flow chart illustrating the method for uplink transmission using an MU PPDU with a single RU according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

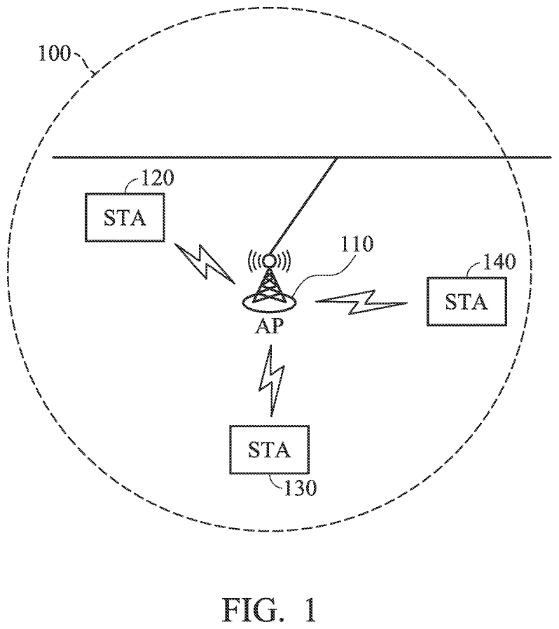

FIG. 1 is a block diagram of a wireless communication system according to an embodiment of the application.

As shown in FIG. 1, the wireless communication system 100 includes an Access Point (AP) 110 and a plurality of stations (STAs) 120˜140. The AP 110 is an entity compatible with IEEE 802.11 standards to provide and manage the access to the wireless medium for the STAs 120˜140.

In one embodiment, the AP 110 may be a High Efficiency (HE) AP or an HE STA operating in the AP mode, which is compatible with the IEEE 802.11ax standards.

In another embodiment, the AP 110 may be an AP which is compatible with any IEEE 802.11 standards later than 802.11ax.

Each of the STAs 120˜140 may be a mobile phone (e.g., feature phone or smartphone), a panel Personal Computer (PC), a laptop computer, or any wireless communication terminal, as long as it is compatible with the same IEEE 802.11 standards as the AP 110. Each of the STAs 120˜140 may operate in the non-AP mode to associate and communicate with the AP 110 for transmitting or receiving data in uplink (UL) or downlink (DL) MU PPDUs.

At a given point in time, multiple STAs 120˜140, in the wireless communication system 100, may wish to transmit/receive data. Instead of scheduling wireless medium access for the STAs 120˜140 in different respective UL/DL time intervals, the AP 110 may schedule wireless medium access for the STAs 120˜140 to support UL/DL MU transmission techniques, according to which the STAs 120˜140 may transmit/receive MU PPDUs to the AP 110 simultaneously during a given time interval. For example, by using DL MU OFDMA techniques during a given DL time interval, the STAs 120˜140 may receive DL MU PPDUs from the AP 110, and in each DL MU PPDU, the same or different RUs may be allocated to the STAs 120˜140.

Alternatively, there may be only one of STAs 120˜140, in the wireless communication system 100, wishes to transmit UL data to the AP 110. In the conventional practice, the single STA generally uses a Single-User (SU) PPDU, instead of the MU PPDU, for uplink transmission. However, the uplink transmission using an SU PPDU may not be efficient or flexible in terms of wireless medium access for STAs.

In accordance with one novel aspect of the present application, a single STA may perform uplink transmission using an MU PPDU (e.g., an HE MU PPDU) with a single RU spanning a partial bandwidth of the MU PPDU. In particular, the partial bandwidth excludes the frequency band of the primary channel and the 20 MHz band(s) which the Clear Channel Assessment (CCA) indicates busy.

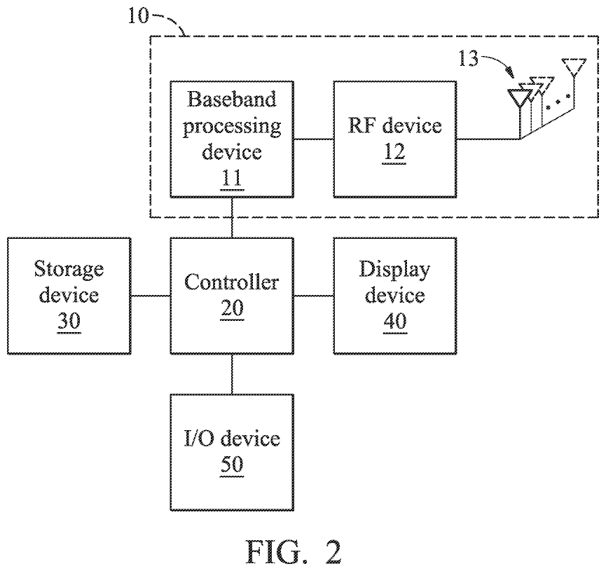

FIG. 2 is a block diagram illustrating an STA according to an embodiment of the application.

As shown in FIG. 2, an STA (e.g., the STA 120, 130, or 140) may include a wireless transceiver 10, a controller 20, a storage device 30, a display device 40, and an Input/Output (I/O) device 50.

The wireless transceiver 10 is configured to perform wireless transmission and reception to and from an AP (e.g., the AP 110). For example, the wireless transceiver 10 may be a Wi-Fi chip.

Specifically, the wireless transceiver 10 may include a baseband processing device 11, a Radio Frequency (RF) device 12, and antenna 13, wherein the antenna 13 may include an antenna array for UL/DL Multiple Input-Multiple-Output (MU-MIMO).

The baseband processing device 11 is configured to perform baseband signal processing, such as Analog-to-Digital Conversion (ADC)/Digital-to-Analog Conversion (DAC), gain adjusting, modulation/demodulation, encoding/decoding, and so on. The baseband processing device 11 may contain multiple hardware components, such as a baseband processor, to perform the baseband signal processing.

The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13. The RF device 12 may also contain multiple hardware devices to perform radio frequency conversion. For example, the RF device 12 may include a mixer to multiply the baseband signals with a carrier oscillated in the radio frequency of the supported cellular technologies, wherein the radio frequency may be 2.4 GHz, 5 GHz, or 60 GHz utilized in the Wi-Fi technology, or any radio frequency utilized in the future evolution of the Wi-Fi technology.

The controller 20 may be a general-purpose processor, a Micro Control Unit (MCU), an application processor, a Digital Signal Processor (DSP), or the like, which includes various circuits for providing the functions of data processing and computing, controlling the wireless transceiver 10 for wireless communications with the AP, storing and retrieving data (e.g., program code) to and from the storage device 30, sending a series of frame data (e.g. representing text messages, graphics, images, etc.) to the display device 40, and receiving user inputs or outputting signals via the I/O device 50.

In particular, the controller 20 coordinates the aforementioned operations of the wireless transceiver 10, the storage device 30, the display device 40, and the I/O device 50 for performing the method of the present application.

In another embodiment, the controller 20 may be incorporated into the baseband processing device 11, to serve as a baseband processor.

As will be appreciated by persons skilled in the art, the circuits of the controller 20 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 2 are for illustrative purposes only and are not intended to limit the scope of the application. For example, an STA may include more components, such as another wireless transceiver for providing telecommunication services, a Global Positioning System (GPS) device for use of some location-based services or applications, and/or a battery for powering the other components of the STA, etc. Alternatively, an STA may include fewer components. For example, the STA may not include the display device 40 and/or the I/O device 50.

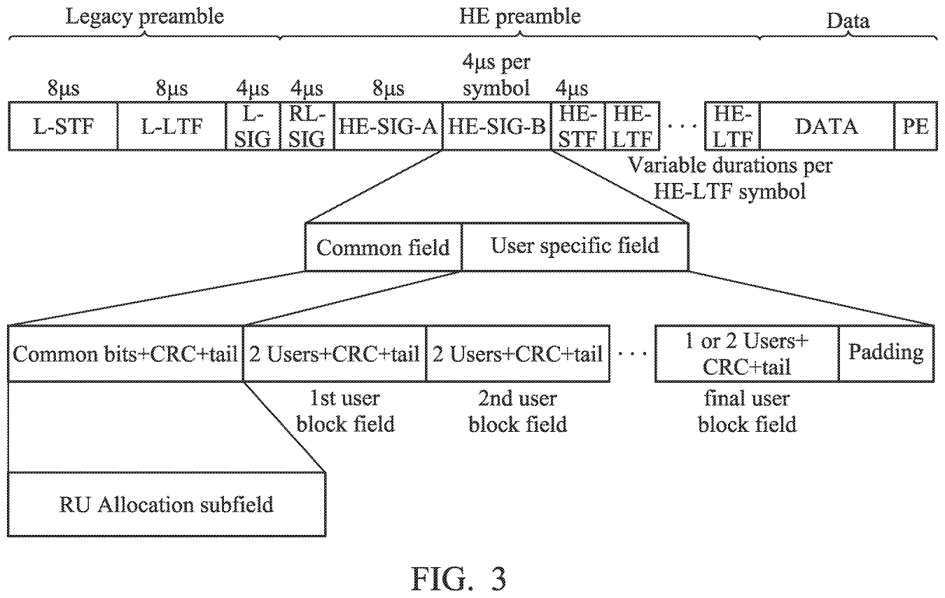

FIG. 3 is a schematic diagram illustrating the format of an UL HE MU PPDU according to an embodiment of the application.

As shown in FIG. 3, the header of the UL HE MU PPDU may include a legacy (non-HE) preamble and an HE preamble. The legacy preamble may include the L-STF, L-LTF and L-SIG, each of which is decodable by legacy devices and is included for backward compatibility and coexistence with the legacy devices, while the HE preamble can only be decoded by 802.11ax devices.

Specifically, the HE preamble may include the RL-SIG, HE-SIG-A, HE-SIG-B, HE-STF, HE-LTF, wherein the RU allocation information may be provided in the HE-SIG-B field, and the HE-SIG-B field is separately encoded on each 20 MHz band.

The HE-SIG-B field may include a common field and a user specific field. The common field may include an RU allocation subfield to specify the RU assignment and the number of users per RU for each 20 MHz bandwidth segment for MU-MIMO cases or for MU-OFDMA multiplexing cases.

The RU Allocation subfield in the common field of HE-SIG-B may consist of 8 bits that indicate this information for each 20 MHz PPDU bandwidth. The mapping from the 8-bit RU Allocation subfield to the RU assignment and the number of user fields per RU contributed to the user specific field in the same HE-SIG-B content channel as the RU Allocation subfield is defined in the IEEE 802.11ax standards, and a portion of the mapping is provided below in Table 1 for the convenience of reference.

TABLE 1

| 8 bits | | | | | | | | | | Number of |
|---|---|---|---|---|---|---|---|---|---|---|
| indices | #1 | #2 | #3 | #4 | #5 | #6 | #7 | #8 | #9 | entities |

| | | | | | | |
|---|---|---|---|---|---|---|
| 01010y₂y₁y₀ | 106 | 26 | 52 | 26 | 26 | 8 |

| 01011y₂y₁y₀ | 106 | | 26 | 52 | 52 | 8 |
|---|---|---|---|---|---|---|
| 0110y₁y₀z₁z₀ | 106 | | — | 106 | | 16 |
| 01110000 | 52 | 52 | — | 52 | 52 | 1 |

| 01110001 | 242-tone RU empty | | | 1 |
|---|---|---|---|---|
| 01110010 | 484-tone RU with zero User fields indicated in this RU | | | 1 |
| | Allocation Subfield of the HE-SIG-B content channel | | | |
| 01110011 | 996-tone RU with zero User fields indicated in this RU | | | 1 |
| | Allocation Subfield of the HE-SIG-B content channel | | | |
| 011101x₁x₀ | Reserved | | | 4 |
| 01111y₂y₁y₀ | Reserved | | | 8 |
| 10y₂y₁y₀z₂z₁z₀ | 106 | 26 | 106 | 64 |

| | | |
|---|---|---|
| 11000y₂y₁y₀ | 242 | 8 |
| 11001y₂y₁y₀ | 484 | 8 |
| 11010y₂y₁y₀ | 996 | 8 |

The user specific field may include multiple user block fields, each of which includes one or two user fields to indicate the identification information (i.e., the STA Identifiers (IDs)) of the STAs that is used to decode their payloads. Specifically, each user field may include a STA-ID subfield which is used to identify the STA that is the sender of an RU in the HE MU PPDU. According to the IEEE 802.11ax standards, if an RU is addressed from an associated non-AP STA, the STA-ID subfield for that RU is set to the 11 Least Significant Bits (LSBs) of the Association ID (AID) of the STA transmitting the Physical layer Service Data Unit (PSDU) contained in that RU. If an RU is intended for no user, the STA-ID subfield for that RU is set to a value (e.g., 2046) indicating “unallocated RU” or any reserved value (e.g., 2008˜2044 or 2047˜4094) to provide the same indication.

Note that the HE-SIG-B field may contain one or more HE-SIG-B content channels. Specifically, the HE-SIG-B field of a 20 MHz HE MU PPDU contains one HE-SIG-B content channel, while the HE-SIG-B field of an HE MU PPDU that is 40 MHz or wider contains two HE-SIG-B content channels.

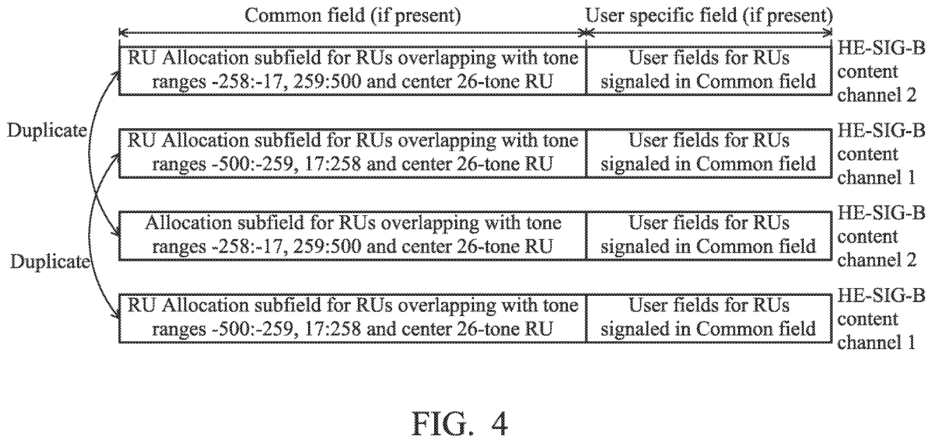

FIG. 4 is a schematic diagram illustrating the HE-SIG-B content channels and their duplication in an 80 MHz HE MU PPDU according to an embodiment of the application.

As shown in FIG. 4, the HE-SIG-B field of an 80 MHz HE MU PPDU contains two HE-SIG-B content channels, each of which is duplicated once. The HE-SIG-B content channel 1 occupies the 20 MHz frequency segment that is the lowest in frequency and is duplicated on the 20 MHz frequency segment that is the third lowest in frequency. The HE-SIG-B content channel 2 occupies the 20 MHz frequency segment that is the second lowest in frequency and is duplicated on the 20 MHz frequency segment that is the fourth lowest in frequency.

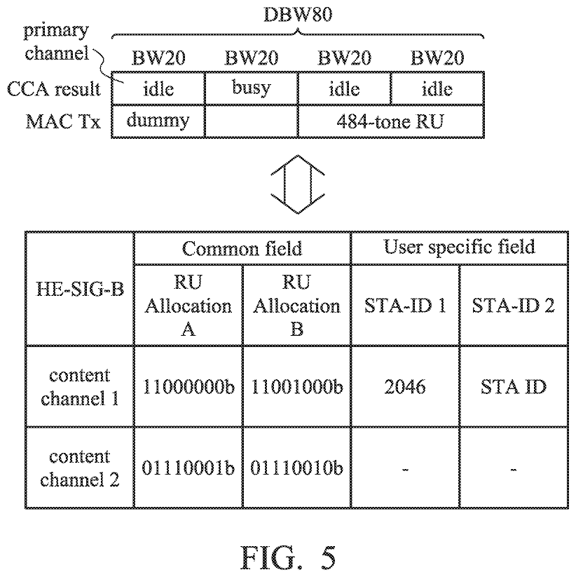

FIG. 5 is a schematic diagram illustrating the RU allocation of an UL MU PPDU according to an embodiment of the application.

As shown in FIG. 5, the UL MU PPDU is a 80 MHz HE MU PPDU, wherein the lowest 20 MHz band is configured as the primary channel. In particular, the non-AP HE STA which transmits the HE MU PPDU performs CCA on each 20 MHz band, and detects that the second lowest 20 MHz band is busy and the remaining 20 MHz bands are idle. In response to the CCA results, a 484-tone RU may be allocated on the highest two 20 MHz bands to carry the uplink data of the non-AP HE STA to the AP.

For the RU allocation corresponding to the lowest 20 MHz band, the non-AP HE STA sets the first RU allocation subfield in the first HE SIG-B content channel to a value (e.g., 11000000 in binary representation) indicating a 242-tone RU, and sets the first STA-ID subfield of the user specific field in the first HE SIG-B content channel to a value (e.g., 2046) indicating that the 242-tone RU is an unallocated RU. In particular, the 242-tone RU is filled with dummy bits, and the subcarriers corresponding to such unallocated RU should not be modulated.

For the RU allocation corresponding to the second highest 20 MHz band, the non-AP HE STA sets the second RU allocation subfield in the first HE SIG-B content channel to a value (e.g., 11001000 in binary representation) indicating a 484-tone RU for a single user, and sets a second STA-ID subfield of the user specific field in the first HE SIG-B content channel to the STA ID (e.g., with a value from 1 to 2007) of the non-AP HE STA.

For the RU allocation corresponding to the second lowest 20 MHz band, the non-AP HE STA sets the first RU allocation subfield in the second HE SIG-B content channel to a value (e.g., 01110001 in binary representation) indicating 242-tone RU empty (i.e., no RU is transmitted on this 20 MHz band), and thus, there is no STA-ID subfield for this RU in the second HE SIG-B content channel.

For the RU allocation corresponding to the highest 20 MHz band, the non-AP HE STA sets the second RU allocation subfield in the second HE SIG-B content channel to a value (e.g., 01110010 in binary representation) indicating 484-tone RU with zero user field, and thus, there is no STA-ID subfield for this RU in the second HE SIG-B content channel.

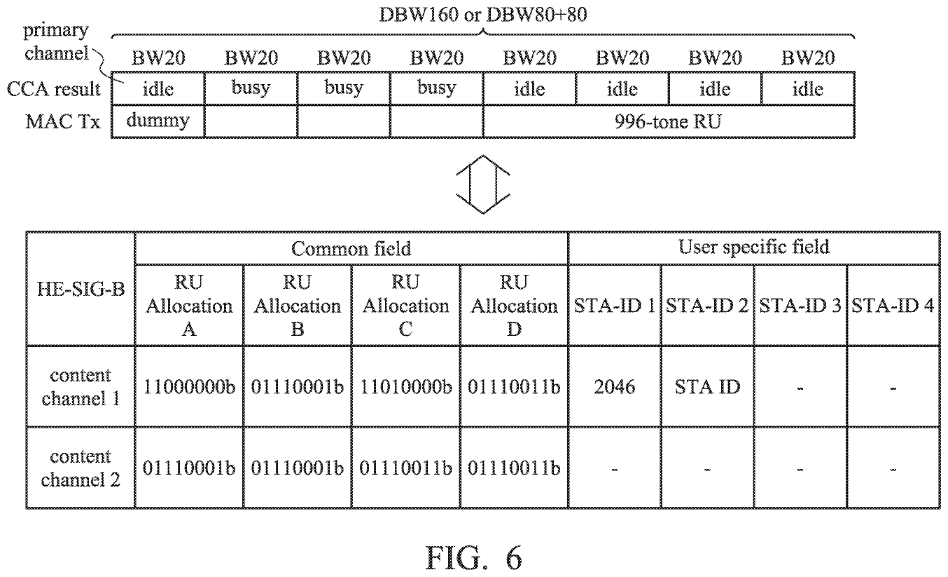

FIG. 6 is a schematic diagram illustrating the RU allocation of an UL MU PPDU according to another embodiment of the application.

As shown in FIG. 6, the UL MU PPDU is a 160 MHz HE MU PPDU, wherein the lowest 20 MHz band is configured as the primary channel. In particular, the non-AP HE STA which transmits the HE MU PPDU performs CCA on each 20 MHz band, and detects that the second, third, and fourth lowest 20 MHz bands are busy and the remaining 20 MHz bands are idle. In response to the CCA results, a 996-tone RU may be allocated on the highest four 20 MHz bands to carry the uplink data of the non-AP HE STA to the AP.

For the RU allocation corresponding to the lowest 20 MHz band, the non-AP HE STA sets the first RU allocation subfield in the first HE SIG-B content channel to a value (e.g., 11000000 in binary representation) indicating a 242-tone RU, and sets the first STA-ID subfield of the user specific field in the first HE SIG-B content channel to a value (e.g., 2046) indicating that the 242-tone RU is an unallocated RU. In particular, the 242-tone RU is filled with dummy bits, and the subcarriers corresponding to such unallocated RU should not be modulated.

For the RU allocation corresponding to the third lowest 20 MHz band, the non-AP HE STA sets the second RU allocation subfield in the first HE SIG-B content channel to a value (e.g., 01110001 in binary representation) indicating 242-tone RU empty (i.e., no RU is transmitted on this 20 MHz band), and thus, there is no STA-ID subfield for this RU in the first HE SIG-B content channel.

For the RU allocation corresponding to the fourth highest 20 MHz band, the non-AP HE STA sets the third RU allocation subfield in the first HE SIG-B content channel to a value (e.g., 11010000 in binary representation) indicating a 996-tone RU for a single user, and sets a third STA-ID subfield of the user specific field in the first HE SIG-B content channel to the STA ID of the non-AP HE STA.

For the RU allocation corresponding to the second highest 20 MHz band, the non-AP HE STA sets the fourth RU allocation subfield in the first HE SIG-B content channel to a value (e.g., 01110011 in binary representation) indicating 996-tone RU with zero user field, and thus, there is no STA-ID subfield for this RU in the first HE SIG-B content channel.

For the RU allocation corresponding to the second lowest 20 MHz band, the non-AP HE STA sets the first RU allocation subfield in the second HE SIG-B content channel to a value (e.g., 01110001 in binary representation) indicating 242-tone RU empty (i.e., no RU is transmitted on this 20 MHz band), and thus, there is no STA-ID subfield for this RU in the second HE SIG-B content channel.

For the RU allocation corresponding to the fourth lowest 20 MHz band, the non-AP HE STA sets the second RU allocation subfield in the second HE SIG-B content channel to a value (e.g., 01110001 in binary representation) indicating 242-tone RU empty (i.e., no RU is transmitted on this 20 MHz band), and thus, there is no STA-ID subfield for this RU in the second HE SIG-B content channel.

For the RU allocation corresponding to the third highest 20 MHz band, the non-AP HE STA sets the third RU allocation subfield in the second HE SIG-B content channel to a value (e.g., 01110011 in binary representation) indicating 996-tone RU with zero user field, and thus, there is no STA-ID subfield for this RU in the second HE SIG-B content channel.

For the RU allocation corresponding to the highest 20 MHz band, the non-AP HE STA sets the fourth RU allocation subfield in the second HE SIG-B content channel to a value (e.g., 01110011 in binary representation) indicating 996-tone RU with zero user field, and thus, there is no STA-ID subfield for this RU in the second HE SIG-B content channel.

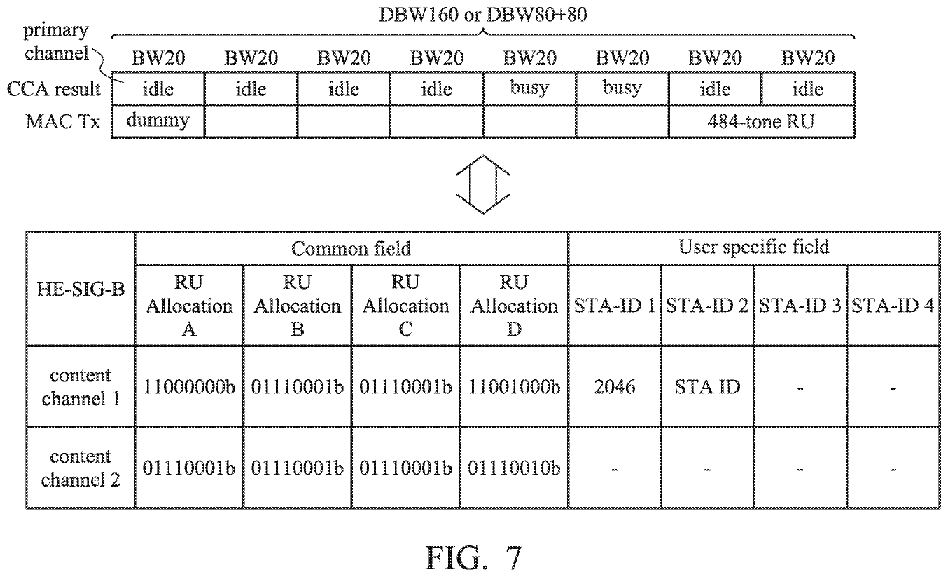

FIG. 7 is a schematic diagram illustrating the RU allocation of an UL MU PPDU according to another embodiment of the application.

As shown in FIG. 7, the UL MU PPDU is a 160 MHz HE MU PPDU, wherein the lowest 20 MHz band is configured as the primary channel. In particular, the non-AP HE STA which transmits the HE MU PPDU performs CCA on each 20 MHz band, and detects that the third and fourth highest 20 MHz bands are busy and the remaining 20 MHz bands are idle. In response to the CCA results, a 484-tone RU may be allocated on the highest two 20 MHz bands to carry the uplink data of the non-AP HE STA to the AP.

For the RU allocation corresponding to the lowest 20 MHz band, the non-AP HE STA sets the first RU allocation subfield in the first HE SIG-B content channel to a value (e.g., 11000000 in binary representation) indicating a 242-tone RU, and sets the first STA-ID subfield of the user specific field in the first HE SIG-B content channel to a value (e.g., 2046) indicating that the 242-tone RU is an unallocated RU. In particular, the 242-tone RU is filled with dummy bits, and the subcarriers corresponding to such unallocated RU should not be modulated.

For the RU allocation corresponding to the third lowest 20 MHz band, the non-AP HE STA sets the second RU allocation subfield in the first HE SIG-B content channel to a value (e.g., 01110001 in binary representation) indicating 242-tone RU empty (i.e., no RU is transmitted on this 20 MHz band), and thus, there is no STA-ID subfield for this RU in the first HE SIG-B content channel.

For the RU allocation corresponding to the fourth highest 20 MHz band, the non-AP HE STA sets the third RU allocation subfield in the first HE SIG-B content channel to a value (e.g., 01110001 in binary representation) indicating 242-tone RU empty (i.e., no RU is transmitted on this 20 MHz band), and thus, there is no STA-ID subfield for this RU in the first HE SIG-B content channel.

For the RU allocation corresponding to the second highest 20 MHz band, the non-AP HE STA sets the fourth RU allocation subfield in the first HE SIG-B content channel to a value (e.g., 11001000 in binary representation) indicating 484-tone RU for a single user, and sets a second STA-ID subfield of the user specific field in the first HE SIG-B content channel to the STA ID of the non-AP HE STA.

For the RU allocation corresponding to the second lowest 20 MHz band, the non-AP HE STA sets the first RU allocation subfield in the second HE SIG-B content channel to a value (e.g., 01110001 in binary representation) indicating 242-tone RU empty (i.e., no RU is transmitted on this 20 MHz band), and thus, there is no STA-ID subfield for this RU in the second HE SIG-B content channel.

For the RU allocation corresponding to the fourth lowest 20 MHz band, the non-AP HE STA sets the second RU allocation subfield in the second HE SIG-B content channel to a value (e.g., 01110001 in binary representation) indicating 242-tone RU empty (i.e., no RU is transmitted on this 20 MHz band), and thus, there is no STA-ID subfield for this RU in the second HE SIG-B content channel.

For the RU allocation corresponding to the third highest 20 MHz band, the non-AP HE STA sets the third RU allocation subfield in the second HE SIG-B content channel to a value (e.g., 01110001 in binary representation) indicating 242-tone RU empty (i.e., no RU is transmitted on this 20 MHz band), and thus, there is no STA-ID subfield for this RU in the second HE SIG-B content channel.

For the RU allocation corresponding to the highest 20 MHz band, the non-AP HE STA sets the fourth RU allocation subfield in the second HE SIG-B content channel to a value (e.g., 01110010 in binary representation) indicating 484-tone RU with zero user field, and thus, there is no STA-ID subfield for this RU in the second HE SIG-B content channel.

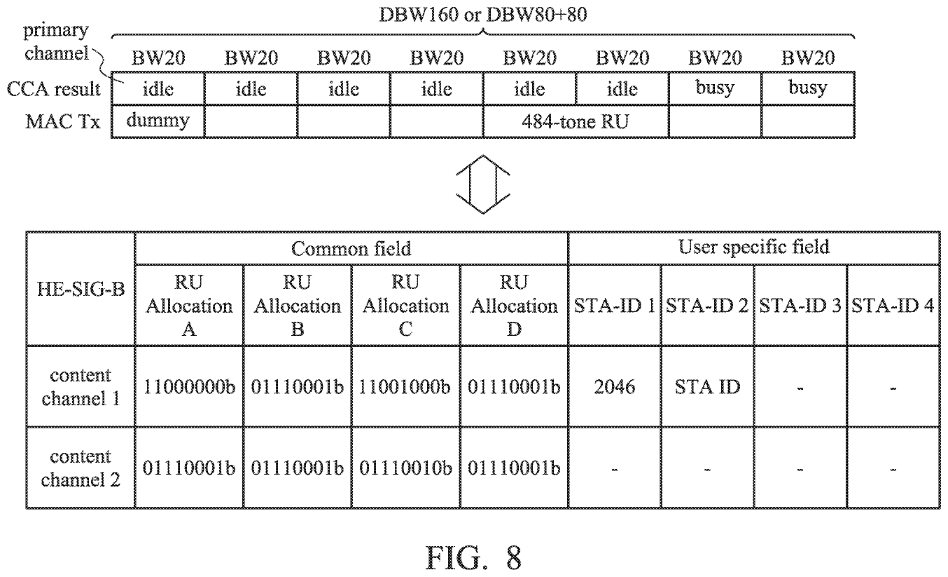

FIG. 8 is a schematic diagram illustrating the RU allocation of an UL MU PPDU according to another embodiment of the application.

As shown in FIG. 7, the UL MU PPDU is a 160 MHz HE MU PPDU, wherein the lowest 20 MHz band is configured as the primary channel. In particular, the non-AP HE STA which transmits the HE MU PPDU performs CCA on each 20 MHz band, and detects that the highest two 20 MHz bands are busy and the remaining 20 MHz bands are idle. In response to the CCA results, a 484-tone RU may be allocated on the third and fourth highest 20 MHz bands to carry the uplink data of the non-AP HE STA to the AP.

For the RU allocation corresponding to the lowest 20 MHz band, the non-AP HE STA sets the first RU allocation subfield in the first HE SIG-B content channel to a value (e.g., 11000000 in binary representation) indicating a 242-tone RU, and sets the first STA-ID subfield of the user specific field in the first HE SIG-B content channel to a value (e.g., 2046) indicating that the 242-tone RU is an unallocated RU. In particular, the 242-tone RU is filled with dummy bits, and the subcarriers corresponding to such unallocated RU should not be modulated.

For the RU allocation corresponding to the third lowest 20 MHz band, the non-AP HE STA sets the second RU allocation subfield in the first HE SIG-B content channel to a value (e.g., 01110001 in binary representation) indicating 242-tone RU empty (i.e., no RU is transmitted on this 20 MHz band), and thus, there is no STA-ID subfield for this RU in the first HE SIG-B content channel.

For the RU allocation corresponding to the fourth highest 20 MHz band, the non-AP HE STA sets the third RU allocation subfield in the first HE SIG-B content channel to a value (e.g., 11001000 in binary representation) indicating 484-tone RU for a single user, and sets a second STA-ID subfield of the user specific field in the first HE SIG-B content channel to the STA ID of the non-AP HE STA.

For the RU allocation corresponding to the second highest 20 MHz band, the non-AP HE STA sets the fourth RU allocation subfield in the first HE SIG-B content channel to a value (e.g., 01110001 in binary representation) indicating 242-tone RU empty (i.e., no RU is transmitted on this 20 MHz band), and thus, there is no STA-ID subfield for this RU in the first HE SIG-B content channel.

For the RU allocation corresponding to the second lowest 20 MHz band, the non-AP HE STA sets the first RU allocation subfield in the second HE SIG-B content channel to a value (e.g., 01110001 in binary representation) indicating 242-tone RU empty (i.e., no RU is transmitted on this 20 MHz band), and thus, there is no STA-ID subfield for this RU in the second HE SIG-B content channel.

For the RU allocation corresponding to the fourth lowest 20 MHz band, the non-AP HE STA sets the second RU allocation subfield in the second HE SIG-B content channel to a value (e.g., 01110001 in binary representation) indicating 242-tone RU empty (i.e., no RU is transmitted on this 20 MHz band), and thus, there is no STA-ID subfield for this RU in the second HE SIG-B content channel.

For the RU allocation corresponding to the third highest 20 MHz band, the non-AP HE STA sets the third RU allocation subfield in the second HE SIG-B content channel to a value (e.g., 01110010 in binary representation) indicating 484-tone RU with zero user field, and thus, there is no STA-ID subfield for this RU in the second HE SIG-B content channel.

For the RU allocation corresponding to the highest 20 MHz band, the non-AP HE STA sets the fourth RU allocation subfield in the second HE SIG-B content channel to a value (e.g., 01110001 in binary representation) indicating 242-tone RU empty (i.e., no RU is transmitted on this 20 MHz band), and thus, there is no STA-ID subfield for this RU in the second HE SIG-B content channel.

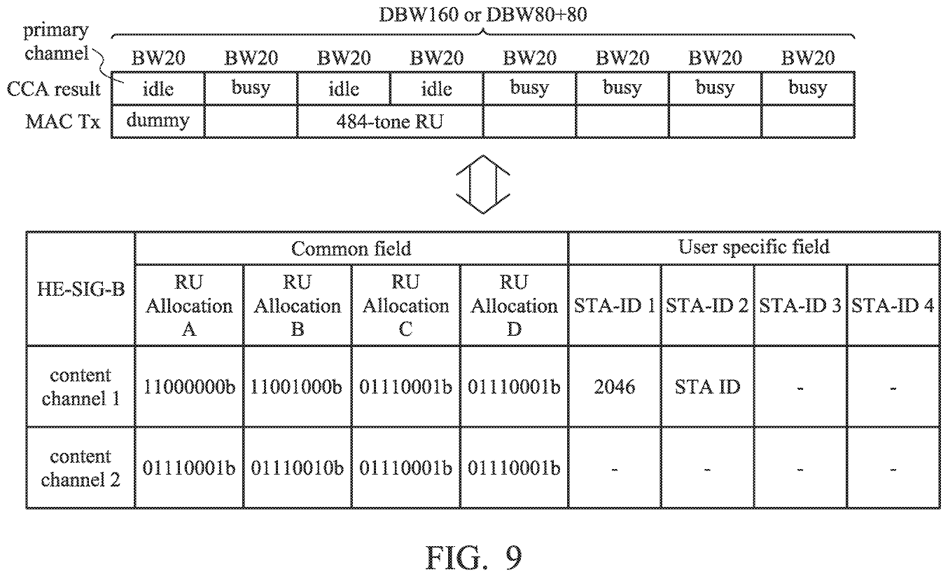

FIG. 9 is a schematic diagram illustrating the RU allocation of an UL MU PPDU according to another embodiment of the application.

As shown in FIG. 9, the UL MU PPDU is a 160 MHz HE MU PPDU, wherein the lowest 20 MHz band is configured as the primary channel. In particular, the non-AP HE STA which transmits the HE MU PPDU performs CCA on each 20 MHz band, and detects that the second lowest and the highest four 20 MHz bands are busy and the remaining 20 MHz bands are idle. In response to the CCA results, a 484-tone RU may be allocated on the third and fourth lowest 20 MHz bands to carry the uplink data of the non-AP HE STA to the AP.

For the RU allocation corresponding to the lowest 20 MHz band, the non-AP HE STA sets the first RU allocation subfield in the first HE SIG-B content channel to a value (e.g., 11000000 in binary representation) indicating a 242-tone RU, and sets the first STA-ID subfield of the user specific field in the first HE SIG-B content channel to a value (e.g., 2046) indicating that the 242-tone RU is an unallocated RU. In particular, the 242-tone RU is filled with dummy bits, and the subcarriers corresponding to such unallocated RU should not be modulated.

For the RU allocation corresponding to the third lowest 20 MHz band, the non-AP HE STA sets the second RU allocation subfield in the first HE SIG-B content channel to a value (e.g., 11001000 in binary representation) indicating 484-tone RU for a single user, and sets a second STA-ID subfield of the user specific field in the first HE SIG-B content channel to the STA ID of the non-AP HE STA.

For the RU allocation corresponding to the fourth highest 20 MHz band, the non-AP HE STA sets the third RU allocation subfield in the first HE SIG-B content channel to a value (e.g., 01110001 in binary representation) indicating 242-tone RU empty (i.e., no RU is transmitted on this 20 MHz band), and thus, there is no STA-ID subfield for this RU in the first HE SIG-B content channel.

For the RU allocation corresponding to the second highest 20 MHz band, the non-AP HE STA sets the fourth RU allocation subfield in the first HE SIG-B content channel to a value (e.g., 01110001 in binary representation) indicating 242-tone RU empty (i.e., no RU is transmitted on this 20 MHz band), and thus, there is no STA-ID subfield for this RU in the first HE SIG-B content channel.

For the RU allocation corresponding to the second lowest 20 MHz band, the non-AP HE STA sets the first RU allocation subfield in the second HE SIG-B content channel to a value (e.g., 01110001 in binary representation) indicating 242-tone RU empty (i.e., no RU is transmitted on this 20 MHz band), and thus, there is no STA-ID subfield for this RU in the second HE SIG-B content channel.

For the RU allocation corresponding to the fourth lowest 20 MHz band, the non-AP HE STA sets the second RU allocation subfield in the second HE SIG-B content channel to a value (e.g., 01110010 in binary representation) indicating 484-tone RU with zero user field, and thus, there is no STA-ID subfield for this RU in the second HE SIG-B content channel.

For the RU allocation corresponding to the third highest 20 MHz band, the non-AP HE STA sets the third RU allocation subfield in the second HE SIG-B content channel to a value (e.g., 01110001 in binary representation) indicating 242-tone RU empty (i.e., no RU is transmitted on this 20 MHz band), and thus, there is no STA-ID subfield for this RU in the second HE SIG-B content channel.

For the RU allocation corresponding to the highest 20 MHz band, the non-AP HE STA sets the fourth RU allocation subfield in the second HE SIG-B content channel to a value (e.g., 01110001 in binary representation) indicating 242-tone RU empty (i.e., no RU is transmitted on this 20 MHz band), and thus, there is no STA-ID subfield for this RU in the second HE SIG-B content channel.

Please note that the RU allocation alternatives described in the embodiments of FIG. 5-9 are for illustrative purposes only and are not intended to limit the scope of the application. For example, the primary channel may be configured to be on the higher channel and the allocation of the single RU in the UL MU PPDU may vary depending on whether the primary channel is on the lower channel or higher channel.

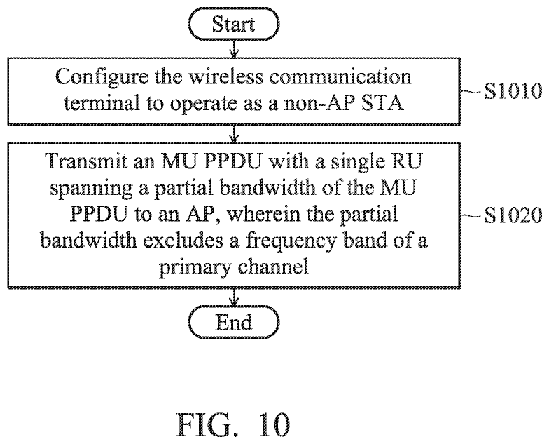

FIG. 10 is a flow chart illustrating the method for uplink transmission using an MU PPDU with a single RU according to an embodiment of the application.

In this embodiment, the method for uplink transmission using an MU PPDU with a single RU may be applied to and executed by a wireless communication terminal, such as the STA 120/130/140.

In step S1010, the wireless communication terminal configures itself to operate as a non-AP STA. For example, the wireless communication terminal may operate as a non-AP HE STA if it supports wireless communication in compliance with the IEEE 802.11ax standards.

In step S1020, the wireless communication terminal transmits an MU PPDU with a single RU spanning a partial bandwidth of the MU PPDU to an AP, wherein the partial bandwidth excludes a frequency band of a primary channel. For example, the MU PPDU may be an HE MU PPDU in compliance with the IEEE 802.11ax standards.

In view of the forgoing embodiments, it will be appreciated that the present application realizes a more efficient and flexible way for a non-AP STA to access the wireless medium, by allowing the non-AP STA to perform uplink transmission using an MU PPDU with a single RU spanning partial bandwidth of the MU PPDU.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A wireless communication terminal, comprising:
a wireless transceiver, configured to perform wireless transmission and reception to and from an AP; and
a controller, coupled to the wireless transceiver, and operable to configure the wireless communication terminal to operate as a non-Access Point (non-AP) Station (STA), and transmit a Multi-User Physical layer Protocol Data Unit (MU PPDU) with a single Resource Unit (RU) spanning a partial bandwidth of the MU PPDU to the AP via the wireless transceiver, wherein the partial bandwidth excludes a frequency band of a primary channel.

2. The wireless communication terminal as claimed in claim 1, wherein the MU PPDU is a High Efficiency (HE) MU PPDU in compliance with Institute of Electrical and Electronics Engineers (IEEE) 802.11ax standards.

3. The wireless communication terminal as claimed in claim 2, wherein a preamble of the HE MU PPDU comprises an HE signal B (HE-SIG-B) field which is separately encoded on each 20 MHz band.

4. The wireless communication terminal as claimed in claim 2, wherein the HE-SIG-B field comprises a common field and a user specific field, the common field comprises a first RU allocation subfield corresponding to the primary channel and a second RU allocation subfield corresponding to the RU, and the user specific field comprises a first STA-ID subfield corresponding to the first RU allocation subfield and a second STA-ID subfield corresponding to the second RU allocation subfield.

5. The wireless communication terminal as claimed in claim 3, wherein the controller further sets the first STA-ID subfield to a value indicating an unallocated RU, and sets the second STA-ID subfield to a STA Identifier (ID) of the non-AP STA.

6. The wireless communication terminal as claimed in claim 3, wherein the controller further sets the first RU allocation subfield to a value indicating a 242-tone RU, and sets the second RU allocation subfield to a value indicating a 484-tone RU or a 996-tone RU.

7. The wireless communication terminal as claimed in claim 5, wherein the controller further fills the 242-tone RU with dummy bits.

8. The wireless communication terminal as claimed in claim 3, wherein the HE-SIG-B field comprises a first HE-SIG-B content channel and a second HE-SIG-B content channel, the common field is a first common field corresponding to the first HE-SIG-B content channel, and the user specific field is a first user specific field corresponding to the first HE-SIG-B content channel.

9. The wireless communication terminal as claimed in claim 1, wherein the controller further performs a Clear Channel Assessment (CCA) on each 20 MHz band, and the partial bandwidth excludes one or more 20 MHz bands which the CCA indicates busy.

10. A method, executed by a wireless communication terminal, the method comprising:
configuring the wireless communication terminal to operate as a non-Access Point (non-AP) Station (STA); and
transmitting a Multi-User Physical layer Protocol Data Unit (MU PPDU) with a single Resource Unit (RU) spanning a partial bandwidth of the MU PPDU to an AP, wherein the partial bandwidth excludes a frequency band of a primary channel.

11. The method as claimed in claim 10, wherein the MU PPDU is a High Efficiency (HE) MU PPDU in compliance with Institute of Electrical and Electronics Engineers (IEEE) 802.11ax standards.

12. The method as claimed in claim 11, wherein a preamble of the HE MU PPDU comprises an HE signal B (HE-SIG-B) field which is separately encoded on each 20 MHz band.

13. The method as claimed in claim 12, wherein the HE-SIG-B field comprises a common field and a user specific field, the common field comprises a first RU allocation subfield corresponding to the primary channel and a second RU allocation subfield corresponding to the RU, and the user specific field comprises a first STA-ID subfield corresponding to the first RU allocation subfield and a second STA-ID subfield corresponding to the second RU allocation subfield.

14. The method as claimed in claim 13, further comprising:
setting the first STA-ID subfield to a value indicating an unallocated RU; and
setting the second STA-ID subfield to a STA Identifier (ID) of the non-AP STA.

15. The method as claimed in claim 13, further comprising:
setting the first RU allocation subfield to a value indicating a 242-tone RU; and
setting the second RU allocation subfield to a value indicating a 484-tone RU or a 996-tone RU.

16. The method as claimed in claim 15, further comprising:
filling the 242-tone RU with dummy bits.

17. The method as claimed in claim 13, wherein the HE-SIG-B field comprises a first HE-SIG-B content channel and a second HE-SIG-B content channel, the common field is a first common field corresponding to the first HE-SIG-B content channel, and the user specific field is a first user specific field corresponding to the first HE-SIG-B content channel.

18. The method as claimed in claim 10, further comprising:
performing a Clear Channel Assessment (CCA) on each 20 MHz band, wherein the partial bandwidth excludes one or more 20 MHz bands which the CCA indicates busy.
